(19) United States
(12) Patent Application Publication
(10) Pub. No.: US 2015/0376747 A1
(43) Pub. Date: Dec. 31, 2015

(54) CAST IRON AND BRAKE COMPONENT

(71) Applicant: KABUSHIKI KAISHA RIKEN, Tokyo (JP)

(72) Inventors: Mojin Tyou, Niigata (JP); Kimiaki Furuya, Niigata (JP); Hiroyuki Watanabe, Saitama (JP); Masaki Shinkawa, Saitama (JP)

(21) Appl. No.: 14/765,194

(22) PCT Filed: Jan. 27, 2014
(86) PCT No.: PCT/JP2014/051645

§ 371 Date: Jul. 31, 2015

(30) Foreign Application Priority Data
Feb. 1, 2013 (JP) 2013-018070

(51) Int. Cl. C22C 37/06; F16D 65/12; C22C 37/10

(52) U.S. Cl. CPC C22C 37/06; C22C 37/10; F16D 65/125

(57) ABSTRACT

A cast iron comprising: C: 3.0 to 4.8 mass %, Si: 3.5 to 5.0 mass %, Mn: 0.5 to 2.0 mass %, Sn and/or Sb where Sn: 0.02 to 0.2 mass %, Sb: 0.01 to 0.2 mass %, Cu: 0.5 mass % or less and the balance: Fe and inevitable impurities.

### FIELD OF THE INVENTION

The present invention relates to cast iron and a brake component favorably used in a brake device of a vehicle. In particular, the present invention relates to cast iron and a brake component having a high specific heat, thereby achieving a lightweight brake disk.

### DESCRIPTION OF THE RELATED ART

A brake device of an automobile or a motorcycle is equipped with a brake disk rotating with a wheel, and a brake pad pressed to the brake disk. In order to inhibit a decrease in functionality caused by a frictional heat generated, the brake disk should have a high thermal conductivity. A material for realizing the need with low costs, flake graphite cast iron, CV graphite cast iron and spheroidal graphite cast iron have been used in the related art. In particular, in the case of flake graphite cast iron, as graphite is a good thermal conductor, graphite is processed to be long, thereby improving the thermal conductivity.

Prior Art Documents relating to cast iron are as follows: Patent Literature 1 relates to anticorrosive cast iron including C: 2.8 to 4 mass %, Si: 1.5 to 3.0 mass %, Mn: 0.3 to 1.2 mass %, P: 0.2 mass % or less, S: 0.06 to 0.25 mass %, Cu: 0.15 to 3.5 mass % and the balance: Fe and inevitable impurities with carbon equivalent of 3.8 to 4.5%, by changing a content of Cu to suppress corrosion.

Patent Literature 2 relates to a disk for a disk brake including C: 2.8 to 3.8 mass %, Si: 1.8 to 3.4 mass %, Mn: 0.5 to 1.0 mass %, S: 0.02 to 0.1 mass %, Cr: 0.1 to 1.5 mass %, Mo: 0.1 to 1.0 mass %, Ni: 0.1 to 1.2 mass %, Ce: 0.01 to 0.05 mass %, Cu: 0.1 to 1.2 mass % and the balance: Fe and inevitable impurities, by highly strengthening with Ce to improve a heat crack resistance.

Patent Literature 3 relates to a brake component having a sliding unit and a hub attachment unit that is made of cast iron in an integrated structure by single molten metal, including C: 3.5 to 3.90 mass %, Si: 2.3 to 3.0 mass %, Mn: 0.7 to 1.1 mass %, P: <0.05 mass %, S: 0.08 to 0.012 mass %, Cu: 0.7 to 1.2 mass % and the balance: Fe and inevitable impurities, and having a CE value of 4.3 to 4.7, a tensile strength of 15 to 20 kgf/mm², and a damping capacity of 12 to 20×10⁻³. To an inner surface of a hub attachment hole, induction hardening is applied so as to have a hardness of HRB 90 to 105.

Patent Literature 4 relates to high thermal conductive and anticorrosive cast iron including C: 3 to 4.5 mass %, Si: 1.5 to 3.0 mass %, Mn: 0.5 to 1.5 mass %, P: 0.2 mass % or less, S: 0.06 to 0.25 mass %, Cu: 0.15 to 3.5 mass %, Ca: 0.02 to 0.1 mass %, Al: 0.02 to 0.1% and the balance: Fe and inevitable impurities with carbon equivalent of 4 to 5%, by producing needle-like graphite in the structure to improve a high thermal conductivity and a corrosion resistance.

### PRIOR ART DOCUMENTS

### Patent Literatures

### [Patent Literature 1] Japanese Examined Patent Publication S59-011653

### [Patent Literature 2] Japanese Unexamined Patent Publication 2002-105581

### [Patent Literature 3] Japanese Unexamined Patent Publication Hei05-214480

### [Patent Literature 4] Japanese Unexamined Patent Publication Hei07-3380

### SUMMARY OF THE INVENTION

### Problems to be Solved by the Invention

In recent years, a transportation apparatus such as an automobile is needed to further reduce a weight accompanied by an emission control of a greenhouse effect gas. In particular, a brake disk made of cast iron aggregate is appreciably heavy, and is strongly needed to reduce a weight.

Braking by the brake disk and the brake pad is accompanied by an action to convert kinetic energy into thermal energy. The brake disk absorbs thermal energy, and radiate the thermal energy after the vehicle is stopped. Accordingly, the higher the thermal conductivity of the brake disk is, the faster the thermal energy can be radiated. Also, the higher the specific heat of the brake disk is, the higher a capacity to store the thermal energy is, whereby an increase in temperature can be inhibited when the thermal energy is absorbed. Therefore, the higher the specific heat of the brake disk is, the smaller the brake disk is.

However, cast iron is not yet developed at present by focusing to have a high specific heat.

In general, cast iron includes a relatively large amount of Cu in order to reliably provide strength and an abrasion resistance. However, Cu is a high cost material. Therefore, decreasing Cu is desirable.

The present invention is made in view of the circumstances. An object is to provide cast iron and a brake component, where a content of Cu is decreased to reduce costs and a specific heat is high to reduce a weight of the brake component.

### Means for Solving the Problem

The present inventors have been studied for reducing a weight of cast iron and a brake disk using the same. As a result, it has been concluded that if cast iron having the following composition is used, a specific heat can be high (for example, 600 J/kg/K or more), and an emission control of a greenhouse effect gas can be sufficiently provided. Further studies have been made in order to provide such a specific heat.

Cast iron is composed of ferrite, cementite, graphite and a minor amount of other inclusions. The present inventors have been studied for increasing a specific heat of ferrite having a greatest weight fraction, and for widely investigating elements that can be dissolved in ferrite and have an effect to increase a specific heat. As a result, it has been found that Si has a greatest effect, and can be dissolved easily in ferrite without forming carbide.

The effect of Si is significantly exerted when 3.5% or more Si is added to cast iron. Si is concentrated in the cast iron, mainly in ferrite. A weight fraction of Si in the ferrite is 4% or more. In general, it is said that, at the concentration, Fe₃Si is precipitated in an equilibrium state. From a result of an analysis by X ray diffraction, Fe₃Si is little detected under normal production conditions. In other words, it is contemplated that Si does not form an ordered structure, is dissolved irregularly and is supersaturated, thereby improving a specific heat of the ferrite.

The cast iron according to the present invention is based on the above-described discoveries, and includes C: 3.0 to 4.8 mass %, Si: 3.5 to 5.0 mass %, Mn: 0.5 to 2.0 mass %, Sn and/or Sb where Sn: 0.02 to 0.2 mass %, Sb: 0.01 to 0.2 mass %, Cu: 0.5 mass % or less and the balance: Fe and inevitable impurities.

Preferably, the cast iron of the present invention further comprises: Cr: 0.05 to 1.5 mass %.

Preferably, a specific heat of the cast iron of the present invention at 200° C. is 600 J/kg/K or more. Preferably, a thermal conductivity of the cast iron of the present invention at 200° C. is 44 W/m/K or more.

Preferably, a pearlite area ratio of the cast iron of the present invention in a matrix structure is 90% or more.

Also, the present invention provides a brake component produced by the cast iron.

Hereinafter, a ground of each numerical limitation is described together with a working of the present invention. Note that “%” means “mass %” in the following description.

### C: 3.0 to 4.8%

C is a necessary element for precipitating graphite in a matrix structure. Graphite is a good thermal conductor and exerts effects that a thermal conductivity of cast iron is improved and thermal energy absorbed is rapidly radiated. If a content of C is less than 3.0%, it becomes difficult to provide 44 W/m/K that is a thermal conductivity similar to that of cast iron as an existing material. On the other hand, the content of C exceeds 4.8%, a melting point of cast iron becomes too high to be dissolved, and strength is significantly decreased, whereby it is difficult to be added. Therefore, the content of C is 3.0 to 4.8%.

### Si: 3.5 to 5.0%

Si is an element for increasing a specific heat of cast iron. If a content of Si is less than 3.5%, it becomes difficult to provide 600 J/kg/K that is a target specific heat. On the other hand, the content of Si exceeds 5%, a viscosity of molten metal is increased, resulting in a difficulty in casting. Therefore, the content of Si is 3.5 to 5.0%.

### Mn: 0.5 to 2.0%

Mn is incorporated from a raw material scrap, and has an effect to strengthen a matrix structure. If a content of Mn is less than 0.5%, such an effect is poor. On the other hand, if the content of Mn exceeds 2%, the matrix structure is significantly chilled, thereby decreasing machinability. Therefore, the content of Mn is 0.5 to 2.0%.

### P: 0.2% or Less

P improves flowability of molten metal, but embrittles cast iron. Therefore, it is desirable that a content of P be 0.2% or less as an inevitable impurity.

### S: 0.25% or Less

If a content of S exceeds 0.25%, a production amount of MnS is excessive, thereby increasing chilling (white solidification) and decreasing machinability. Therefore, it is desirable that a content of S be 0.25% or less as an inevitable impurity.

### Sn and Sb

In the present invention, it is essential to add Si in order to increase a specific heat, Si has an action to promote ferritization. If a ferrite fraction is great, strength and an abrasion resistance are decreased. According to the present invention, in order to promote the matrix structure of changing to pearlite and to improve strength, one type or two types of elements selected from the group consisting of Sn and Sb are included.

Here, in order to reliably provide strength and an abrasion resistance, cast iron includes Cu. Cu has a high material cost. The present inventors have found that elements Sn and Sb promote the matrix structure of changing to pearlite same as Cu. Although Sn and Sb have material costs higher than that of Cu on the same mass basis, the contents of Sn and Sb can be lowered to offer a similar effect of changing to perlite. As a result, the content of Cu can be lowered to 0.5% or less, thereby reducing the costs.

### Cu: 0.5% or Less

As described above, Sn and/or Sb is included as an element for providing the similar effect as Cu, thereby exercises the effect of changing to pearlite, even if the content of Cu is 0.5% or less.

Note that if the content of Sn and/or Sb is increased to the defined range, the content of Cu can be further lowered, in some cases, no Cu may be included. However, a minor amount of Cu is included in a raw material of cast iron. It is therefore substantially difficult to lower the content of Cu to 0 (zero), and about 0.01% of Cu is unavoidably detected. Accordingly, the lower limit of the content of Cu is defined as an inevitable amount. For example, the lower limit may be 0.01%. If cast iron can be produced without including Cu in the future, the content of Cu may be 0 (zero).

### Sn: 0.02% to 0.2%

Sn is an element for inhibiting precipitation of ferrite, and strongly promoting of changing to pearlite. By concentrating Sn at a narrow boundary between graphite and the base matrix, graphite is inhibited from growing caused by a repeat cycle of a frictional heat upon braking and a thermal crack is prevented from propagating. If the content of Sn is less than 0.02%, the effect of changing to pearlite is small. On the other hand, if the content of Sn is exceeding 0.2%, toughness is decreased, and toughness to a heat crack is decreased. Therefore, the content of Sn is 0.02% to 0.2%,

### Sb: 0.01 to 0.20%

Sb is an element for inhibiting precipitation of ferrite, and stabilizing pearlite. Sb contributes to increase hardness of cast iron including A type graphite acquired to downsize graphite in a pearlite base matrix. If the content of Sb is less than 0.01%, it is insufficient to improve the matrix structure, i.e., contribute to stabilizing pearlite. If the content of Sb exceeds 0.2%, an impact value is significantly lowered, and D type graphite is easily formed. The content of Sb is 0.01% to 0.20%.

### Cr: 0.05% to 1.5%

As described above, if Sn and/or Sb is included in cast iron, the content of Cu may be lowered (or the content of Cu may be substantially 0). However, if Sn or Sb is included, carbide may be unstable. It is therefore preferable that Cr is included.

Cr is an element for stabilizing carbide, densifying the structure, and increasing strength. It is desirable that 0.05% or more of Cr be included. Cr is concentrated in cementite, and stabilizes pearlite. In other words, Cr inhibits a grow phenomenon, and has an effect to decrease a volume change ratio by heating or cooling. On the other hand, as Cr is difficult to be molten in ferrite and forms carbide, it less contributes to increase a specific heat. In addition, if the content of Cr exceeds 1.5%, the matrix structure is easily chilled, and machinability is decreased. The upper limit should be 1.5%. Therefore, the content of Cr is 0.05% to 1.5%.

A minor amount of an alloy element such as Ni, Mo and V may be included as described below in order to improve a structure and properties of cast iron.

### Ni: Exceeding 0% and 1.2% or Less

Ni is an element for promoting graphitization and inhibiting chilling, thereby improving machinability. Also, Ni has a function to improve strength of the matrix structure. However, Ni is very expensive, and a large amount of Ni cannot be therefore added. In order to provide both of the above-described effects and the cost reduction, it is desirable that exceeding 0% to 1.2% or less of Ni is included. The lower limit of the content of Ni can be 0.01%, for example.

### Mo: Exceeding 0% and 1.0% or Less

Mo is an element for stabilizing carbide, densifying a structure and improving strength. In order to provide the effects, Mo is preferably included. However, Mo is difficult to be molten in ferrite and forms carbide, it less contributes to increase a specific heat. Therefore, it is desirable that the content of Mo exceeds 0% and be 1.0% or less. The lower limit of the content of Mo can be 0.001%.

### V: Exceeding 0% and 0.35% or Less

V is an element for stabilizing carbide, densifying a structure and improving strength. In order to provide the effects, V is preferably included. However, V is difficult to be molten in ferrite and forms carbide, it less contributes to increase a specific heat. Therefore, it is desirable that the content of V exceeds 0% and be 0.35% or less. The lower limit of the content of V can be 0.01%

As described above, in order to sufficiently reduce a weight (especially, in the case of the brake disk), it is necessary that a specific heat is 600 J/kg/K or more. Here, in an automobile repeating acceleration and braking, an average temperature of the brake disk is about 200° C. It is desirable that a specific heat at 200° C. is 600 J/kg/K or more. In addition, it is desirable that the cast iron according to the present invention has a thermal conductivity at 200° C. is 44 W/m/K or more. In this manner, thermal energy absorbed is rapidly emitted, whereby a heat crack of the brake disk is prevented from generating.

The cast iron according to the present invention is applicable to any of flake graphite cast iron, CV graphite cast iron and spheroidal graphite cast iron. The spheroidal graphite cast iron has a high tensile strength but an insufficient thermal conductivity because of spheroidal graphite. Therefore, the flake graphite cast iron having a high thermal conductivity or the CV graphite cast iron having well balanced thermal conductivity and tensile strength are suitable. Furthermore, the flake graphite cast iron is desirable as long as a low tensile strength is allowable.

According to the present invention, a perlite area ratio in the matrix structure is suitably 90% or more, thereby reliably providing a sufficient strength. Note that the perlite area ratio is calculated using image processing of a metal structure photograph of a cast iron section by (1) extracting a structure excluding graphite, and (2) excluding graphite and ferrite and extracting a pearlite structure in accordance with (area of pearlite)/(areas of pearlite+ferrite).

### Effects of the Invention

According to the present invention, it is found that Si has an effect to increase a specific heat that is not conventionally known. By including 3.5 to 5.0% of Si, cast iron (especially a brake component manufactured from cast iron) can be provided with a high specific heat. In this way, a heat capacity is improved on the same weight basis, thereby inhibiting a temperature increase in a sliding portion due to a frictional heat. Accordingly, lifetimes of cast iron and a component using the same can be prolonged by decreasing a thermal expansion, a heat crack and thermal degradation. In addition, as a weight can be decreased to provide the same thermal capacity, a lightweight brake component can be provided. Furthermore, if the brake component is manufactured from the cast iron, a temperature of an opposite material, i.e., a brake pad, is decreased, whereby a thermal load of the brake pad can be decreased. It is thus possible to use inexpensive constituents in the brake pad.

### BRIEF DESCRIPTION OF DRAWINGS

FIG. 1 A graph showing a relationship between an Si additive amount and a specific heat in Examples according to the present invention.

FIG. 2 A graph showing a relationship between a C additive amount and a thermal conductivity in Examples according to the present invention.

FIG. 3 A graph showing a relationship between a braking time and a temperature in a brake disk.

### EXAMPLES

In order to examine an effect of chemical components and a structure, each cast iron sample having chemical components shown in Table 1 was produced on trial. A specific heat, a pearlite area ratio, and a thermal conductivity in each cast iron sample were measured, and the results shown in Table 1 were provided. In addition, a presence or absence of defects of each cast iron sample upon casting was visually observed. The results are also shown in Table 1.

The specific heat was measured by a differential scanning calorimetry. The thermal conductivity was measured by a laser flash method. The pearlite area ratio was measured as described above. The defects upon casting were “present” if a shrinkage cavity or a cold shut was found by visually observing a surface of each cast iron sample.

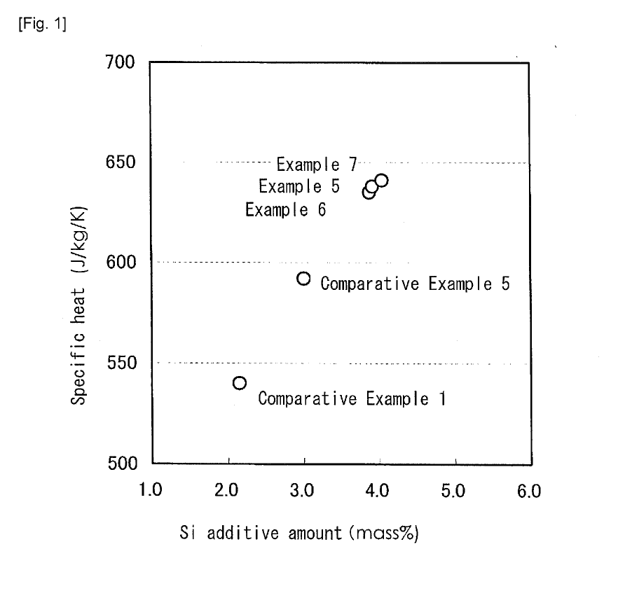

Examples 1 to 8 include chemical components within the range according to the present invention, and Comparative Example 1 is FC250 (gray cast iron) that is an example of a current material. In Comparative Examples 1 to 5, the chemical components not included in the range according to the present invention are underlined. Also, the specific heat, the thermal conductivity and the pearlite area ratio not included in the target range according to the present invention are underlined. FIG. 1 to FIG. 3 are graphs of the results shown in Table 1.

TABLE 1

| | | | | | | | | | | Specific | Thermal | | |
|---|---|---|---|---|---|---|---|---|---|---|---|---|---|
| | Chemical component (ladle value, mass %) | | | | | | | | | heat | conductivity | Pearlite | Casting |
| | C | Si | Mn | P | S | Cu | Cr | Sn | Sb | (J/Kg/K) | (W/m/K) | area ratio % | defect |
| Example 1 | 3.47 | 3.82 | 1.00 | 0.035 | 0.009 | 0.5 | — | 0.08 | — | 629 | 54 | 99 | Absent |
| Example 2 | 3.45 | 3.92 | 1.00 | 0.035 | 0.009 | 0.5 | — | — | 0.05 | 639 | 52 | 99 | Absent |
| Example 3 | 3.43 | 3.84 | 1.00 | 0.035 | 0.009 | 0.5 | — | 0.02 | 0.04 | 630 | 50 | 99 | Absent |
| Example 4 | 3.46 | 3.90 | 1.00 | 0.035 | 0.009 | 0.01 | — | 0.2 | — | 636 | 53 | 99 | Absent |
| Example 5 | 3.44 | 3.92 | 1.00 | 0.035 | 0.009 | 0.01 | — | 0.15 | 0.01 | 638 | 52 | 99 | Absent |
| Example 6 | 3.42 | 3.88 | 1.00 | 0.035 | 0.009 | 0.01 | — | — | 0.20 | 635 | 50 | 99 | Absent |
| Example 7 | 3.45 | 4.05 | 1.20 | 0.035 | 0.009 | 0.01 | 0.5 | 0.10 | 0.04 | 641 | 54 | 99 | Absent |
| Example 8 | 3.08 | 4.00 | 1.20 | 0.035 | 0.009 | 0.01 | 0.5 | 0.10 | 0.04 | 640 | 45 | 99 | Absent |
| Comparative | 3.01 | 2.15 | 0.70 | 0.030 | 0.050 | 0.8 | — | — | — | 540 | 44 | 99 | Absent |
| Example 1 | | | | | | | | | | | | | |
| Comparative | 3.45 | 3.79 | 1.00 | 0.035 | 0.009 | 0.01 | — | — | — | 631 | 50 | 68 | Absent |
| Example 2 | | | | | | | | | | | | | |
| Comparative | 2.69 | 3.79 | 1.00 | 0.035 | 0.009 | 1.10 | — | — | — | 629 | 40 | 99 | Absent |
| Example 3 | | | | | | | | | | | | | |
| Comparative | 3.45 | 5.51 | 1.00 | 0.035 | 0.009 | 0.6 | — | — | — | 730 | 55 | 95 | Present |
| Example 4 | | | | | | | | | | | | | |
| Comparative | 3.45 | 3.01 | 1.00 | 0.037 | 0.009 | 1.0 | — | — | — | 592 | 51 | 99 | Absent |
| Example 5 | | | | | | | | | | | | | |

As apparent from Table 1, in Examples 1 to 8 according to the present invention, the specific heat and the thermal conductivity were higher than and the pearlite area ratio was equal to Comparative Example 1 (a current material), and the content of Cu was 0.5% or less.

In Comparative Example 1, the content of Si was less than 3.5%, and the specific heat thus had a low value. As shown in FIG. 1, in order to provide the specific heat of 600 J/kg/K or more, it is necessary that the content of Si is 3.5% or more.

In Comparative Example 2, the contents of C and Si were at the same level as those in Example 1, but the contents of Sn and Sb, i.e., the elements for changing to pearlite, were zero. As a result, the pearlite area ratio was significantly lowered as compared with those in Examples 1 to 5.

From the standpoint, as shown in Table 1, in order to provide the pearlite area ratio of 90% or more, it is necessary that at least one of Sn and Sb is added.

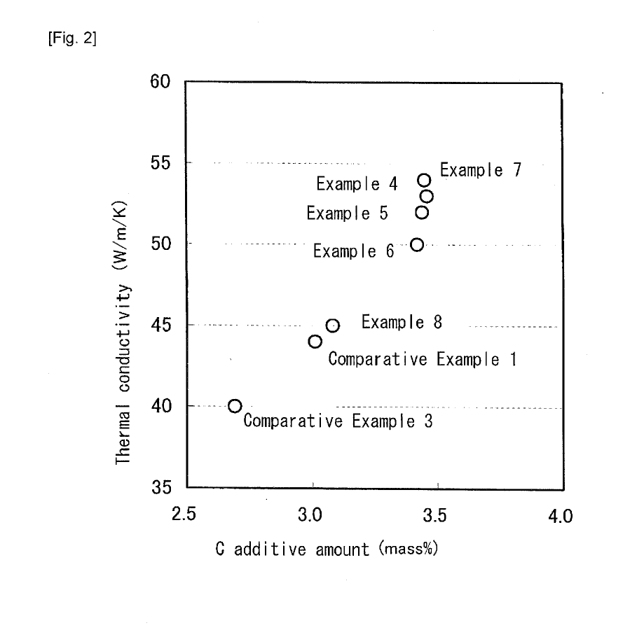

In Comparative Example 3, the content of Si was at the same level as that in Example 1, but the content of C was less than 3.0%. As a result, the thermal conductivity was very low. As shown in FIG. 2, in order to provide the thermal conductivity of 44 W/m/K or more, it is necessary that the content of C is 3.0% or more.

In Comparative Example 4, the content of C was at the same level as that in Example 1, but the content of Si exceeds 5.0%. As shown in Table 1, in Comparative Example 4, the specific heat was very high, but a viscosity of molten metal was high, thereby generating casting defects.

In Comparative Example 5, the content of Si was less than 3.5% that was about 0.8% lower than that in Example 1. The specific heat was higher than that in Comparative Example 1, but did not exceed 600 J/kg/K.

In each Example, by adding at least one of Sn and Sb, 90% or more of the pearlite ratio (the pearlite area ratio) was reliably provided, the specific heat was 600 J/kg/K or more, and the thermal conductivity was 44 W/m/K or more.

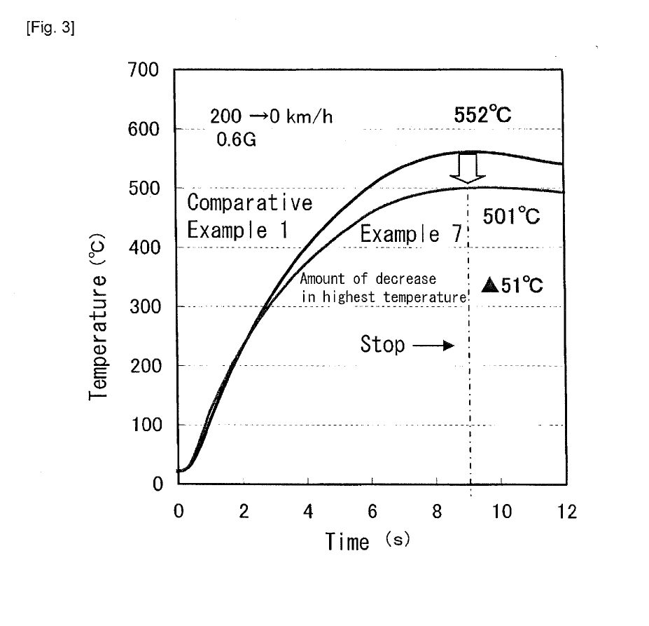

Brake disks having the same type and the same size were produced from the cast iron samples in Example 7 and Comparative Example 1, and were mounted to an automobile. The automobile was slowed down from 200 km/h to 0 km/h with 0.6 G. FIG. 3 shows a change in temperature of the brake disks at this time. It shows that the temperature of the brake disk in Example 7 was significantly lowered as compared with that in Comparative Example 1. That is, in Example 7, as the specific heat was increased, an absorbed amount of thermal energy was high, and the temperature increase of the brake disk was inhibited. Consequently, according to the present invention, it is possible to reduce the weight of the brake disk, to prolong the lifetime of the brake pad, and to reduce the cost of the components of the bake pad in response to the increase in the specific heat of the brake disk.

The present invention is not limited to the disk-shaped brake component, but is applicable to a brake component having any shape including a cylindrical shape and a long plate shape.

### INDUSTRIAL APPLICABILITY

The present invention is applicable to any brake component and a brake device including a brake used for a transportation apparatus such as an automobile, a motorcycle and a train and a brake used for mechanical equipment, e.g., a press.

1. A cast iron comprising: C: 3.0 to 4.8 mass %, Si: 3.5 to 5.0 mass %, Mn: 0.5 to 2.0 mass %, Sn and/or Sb where Sn: 0.02 to 0.2 mass %, Sb: 0.01 to 0.2 mass %, Cu: 0.5 mass % or less and the balance: Fe and inevitable impurities.

2. The cast iron according to claim 1, further comprising: Cr: 0.05 to 1.5 mass %.

3. The cast iron according to claim 1, wherein a specific heat at 200° C. is 600 J/kg/K or more.

4. The cast iron according to claim 1, wherein a thermal conductivity at 200° C. is 44 W/m/K or more.

5. The cast iron according to claim 1, wherein a pearlite area ratio in a matrix structure is 90% or more.

6. A brake component produced by the cast iron according to claim 1.

7. The cast iron according to claim 2, wherein a specific heat at 200° C. is 600 J/kg/K or more.

8. The cast iron according to claim 2, wherein a thermal conductivity at 200° C. is 44 W/m/K or more.

9. The cast iron according to claim 3, wherein a thermal conductivity at 200° C. is 44 W/m/K or more.

10. The cast iron according to claim 2, wherein a pearlite area ratio in a matrix structure is 90% or more.

11. The cast iron according to claim 3, wherein a pearlite area ratio in a matrix structure is 90% or more.

12. The cast iron according to claim 4, wherein a pearlite area ratio in a matrix structure is 90% or more.
